(19) United States
(12) Patent Application Publication
(10) Pub. No.: US 2014/0368442 A1
(43) Pub. Date: Dec. 18, 2014

(54) APPARATUS AND ASSOCIATED METHODS FOR TOUCH USER INPUT

(71) Applicant: Nokia Corporation, Espoo (FI)

(72) Inventor: Miika Juhani VAHTOLA, Oulu (FI)

(21) Appl. No.: 13/917,002

(22) Filed: Jun. 13, 2013

(51) Int. Cl. G06F 3/041; G06F 3/01

(52) U.S. Cl. CPC G06F 3/0412; G06F 3/013
USPC 345/173

(57) ABSTRACT

An apparatus, the apparatus comprising at least one processor, and at least one memory including computer program code, the at least one memory and the computer program code configured, with the at least one processor, to cause the apparatus to perform at least the following: identify a displayed graphical user interface element based on a first selection user input associated with the location of the graphical user interface element on a touch sensitive display; and confirm selection of the identified graphical user interface element based on a second confirmation user input associated with the location of the identified graphical user interface element on the touch sensitive display; wherein the first selection user input and the second confirmation user input are respective different input types of an eye gaze user input and a touch user input.

### TECHNICAL FIELD

The present disclosure relates to user interfaces, associated methods, computer programs and apparatus. Certain disclosed embodiments may relate to portable electronic devices, for example so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed embodiments may provide one or more audio/text/video communication functions (e.g. tele-communication, video-communication, and/or text transmission (Short Message Service (SMS)/Multimedia Message Service (MMS)/e-mailing) functions), interactive/non-interactive viewing functions (e.g., web-browsing, navigation, TV/program viewing functions), music recording/playing functions (e.g., MP3 or other format and/or (FM/AM) radio broadcast recording/playing), downloading/sending of data functions, image capture function (e.g. using a (e.g. in-built) digital camera), and gaming functions.

### BACKGROUND

Electronic devices allow users to select displayed objects in different ways. For example, a user may move a pointer over an object and click a mouse button to select, or touch a touch sensitive display screen over a displayed object to select it.

The listing or discussion of a prior-published document or any background in this specification should not necessarily be taken as an acknowledgement that the document or background is part of the state of the art or is common general knowledge. One or more embodiments of the present disclosure may or may not address one or more of the background issues.

### SUMMARY

In a first example embodiment there is provided an apparatus comprising at least one processor and at least one memory including computer program code, the at least one memory and the computer program code configured to, with the at least one processor, cause the apparatus to perform at least the following: identify a displayed graphical user interface element based on a first selection user input associated with the location of the graphical user interface element on a touch sensitive display; and confirm selection of the identified graphical user interface element based on a second confirmation user input associated with the location of the identified graphical user interface element on the touch sensitive display; wherein the first selection user input and the second confirmation user input are respective different input types of an eye gaze user input and a touch user input.

Thus, for example, a user may hold a finger over a button to select it, and look at the button to confirm the selection and press the button. The button may not be pressed if only a hover input is detected. As another example, a user may look at a two-state switch (e.g., an on/off switch) in a settings menu to select it, and then hover over the switch to confirm the selection and move the switch to the other available position (from on to off, or from off to on. The switch may not move if only a user gaze directed to the switch is detected. Of course, the confirmation input may just confirm the switching done by the detected eye gaze position directed to the switch, and need not itself be a swipe or other translational movement for switching the two-state switch.

The touch sensitive display may be configured to detect one or more of physical touch input and hover touch input. Thus a user may touch a region of a display where the object of interest is displayed, or may hover over the displayed object without touching the screen.

The apparatus may be configured to disambiguate a particular graphical user interface element from one or more adjacent graphical user interface elements associated with the location of the first selection user input by using the second confirmation user input. For example, the location of a user's eye gaze may be determined as an input associated with the location of four adjacent icons in a grid. The user's subsequent hover input may be associated with one of these four icons, thereby disambiguating that particular icon from the other three icons associated with the eye gaze input.

The touch sensitive display may be configured to detect hover touch input, and the apparatus may be configured such that the identification of the graphical user interface element is made based on the touch user input, which is a hover touch user input, using the touch sensitive display and the confirmation of selection is made based on the eye gaze user input. Thus a user may hover over an icon to select it. When the user looks at the same icon, the associated application may open due to the confirmation user gaze input being made. Rather than hover touch input, the input could be physical touch input in some examples.

The touch sensitive display may be configured to detect hover touch input, and the apparatus may be configured such that the identification of the graphical user interface element is made based on the eye gaze user input and the confirmation of selection is made based on the touch user input which is a hover touch user input. For example, a user may look at an object on screen, and select it (for example, to select an option in a settings menu). When the user hovers over the same object, the selected option may be confirmed, for example by saving the selected option (and then closing the settings menu, for example). Again, the input could be physical touch input rather than hover touch input in some examples.

The confirmation of selection of the graphical user interface element may provide for actuation of the functionality associated with the identified graphical user interface element. Thus for example confirmation of selection of an icon may open an associated application, or confirmation of selection of a contact entry may cause a messaging window to be opened for a message to be composed and sent to that contact.

The actuation of the functionality associated with the identified graphical user interface element may comprise one or more of:
opening an application associated with the graphical user interface element (for example, opening a browser window/associated application after confirming selection of an internet browsing application);
selecting an option associated with the graphical user interface element (for example, checking a tick box in a menu and saving the changed settings or selecting an option in a menu); and
initiating a communication with a contact associated with the graphical user interface element (for example, automatically starting a telephone call with a selected contact associated with the graphical user interface element upon confirming selection of that contact).

The identification of the graphical user interface element may be one or more of: a temporary identification, wherein the identification is cancelled upon removal of the user input associated with the location of the graphical user interface element; and a sustained identification, wherein the identification remains after removal of the user input associated with the location of the graphical user interface element for a predetermined time period. Thus in some examples the graphical user interface element may be temporarily selected, and after removal of the selection user input, the selection is cancelled. In some examples, the user may have a predetermined time period within which to confirm the selection with a confirmation user input after removal of the selecting user input.

Removal of the user input associated with the location of the graphical user interface element may be complete removal of the user input (for example, moving the input finger/stylus away from the touch sensitive display such that no input is detected), or may be removal from that particular graphical user interface element by the input finger/stylus moving to a different region of the touch sensitive display (for example to select a different graphical user interface element).

The apparatus may be configured to confirm selection of the displayed graphical user interface element based on one or more of: the touch user input and the eye gaze user input at least partially overlapping in time; and the touch user input and the eye gaze user input being separated in time by an input time period lower than a predetermined input time threshold.

For example, a user may hover a finger over a graphical user interface element, and then also look at the same graphical user interface element while keeping his finger hovering over it. In other examples, the user may look at a graphical user interface element to select it, then move his gaze away and provide a hover user input to the same graphical user interface element within a predetermined time period to confirm selection.

The apparatus may be configured to confirm selection of the identified graphical user interface element after providing a first indication of confirmation following determination of the eye gaze user input associated with the location of the graphical user interface element for a first time period, and providing a second subsequent different indication of confirmation during the continued determined eye gaze user input.

For example, a user may hover over an icon, and a border may appear around that icon and flash to indicate that the icon has been selected. After determining that the user's eye gaze as a second user input is directed to the same icon for a first time period (for example, two seconds) then a first indication of confirmation may be provided, such as changing the flashing border to a non-flashing border. After determining that the user's eye gaze has still been directed to that icon as a continued eye gaze user input, a second subsequent different indication may be provided, such as an audio tone, haptic feedback, or opening an application associated with the icon, for example. In some examples, following determination of the eye gaze user input associated with the location of the graphical user interface element for a first time period, an indication (such as a visual indication) may not necessarily be provided to the user, but an internal confirmation may be performed, for example. During the continued determined eye gaze user input, an indication may be provided, such as opening an application or menu associated with the icon.

The continuation of the determined eye gaze input may be detected by determining that the eye gaze input has been made for a particular continuance period of time following the first time period. For example, if the user continues an eye gaze for a further second time period after the first time period, then this may be determined to be a continuance of the eye gaze user input. The first time period and the further continuance time period may be based on one or more of: manual user specification; automatic threshold determination based on user habit; and provider specification. That is, a user or a provider may specify how long the input periods are, and/or the apparatus may determine what the periods are based on user habits. A user may calibrate the apparatus to set the time periods.

The apparatus may be configured to identify the displayed graphical user interface element by one or more of: a visual highlight indication, a haptic highlight indication, and an audio highlight indication. This highlight may be provided after the first user input, for example by vibrating to indicate that a graphical user interface element has been selected.

The apparatus may be configured to confirm the selection of the identified graphical user interface element by one or more of: a visual highlight indication, a haptic highlight indication, and an audio highlight indication which is different to any highlight provided during the identification of the displayed graphical user interface element by the selection user input. For example, if a vibration is provided to indicate a selection has been made, a coloured background may be displayed behind the graphical user interface element to indicate confirmation of selection.

The apparatus may be configured to provide the visual indication by modifying the display of the graphical user interface element by one or more of: applying a pulsing/variable visual effect, applying a border effect, applying a colour effect, applying a shading effect; changing the size of the graphical user interface element, changing the style of the graphical user interface element.

The touch sensitive display may be configured to detect a hover touch user input made by a stylus (e.g., a finger or pen) pointing to the graphical user interface element displayed on the touch sensitive display at a separation distance of 0 mm or greater from the surface of the touch sensitive display but within the distance range detectable by the touch sensitive display.

The stylus may be a pen, wand, finger, thumb or hand, for example. The touch sensitive display may be configured to detect a physical touch input contacting the display surface, and a hover input during which the stylus does no contact the display surface but is within a hover detection range of the surface (which may be five centimetres, for example).

The apparatus may be configured to perform detection of the touch user input using a capacitive touch sensor. The touch sensor may be, or be laid over, a display screen. The sensor may act as a 3-D hover and touch-sensitive layer which is able to generate a capacitive field (like a virtual mesh) above and around the display screen. The layer may be able to detect hovering objects and objects touching the display screen within the capacitive field as a deformation of the virtual mesh. Thus the shape, location, movements and speed of movement of an object proximal to the layer may be detected.

The apparatus may be configured to perform detection of the eye gaze user input using one or more of: eye-tracking technology and facial recognition technology. Eye-tracking technology may use a visual and/or infra-red (IR) camera and associated software to record the reflection of an infra red beam from images of the user's eyes and use the reflections to determine the eye gaze location. Facial recognition technology may use a front/user-facing camera and associated software to record the position of features on the user's face and determine the user's eye gaze location from these feature positions.

The apparatus may be configured to perform one or more of: detection of the touch user input associated with the displayed graphical user interface element; and detection of the eye gaze user input associated with the displayed graphical user interface element.

The apparatus may be a portable electronic device, a mobile phone, a smartphone, a tablet computer, a surface computer, a laptop computer, a personal digital assistant, a graphics tablet, a digital camera, a watch, a pen-based computer, a non-portable electronic device, a desktop computer, a monitor/display, a household appliance, a server, or a module for one or more of the same.

According to a further example embodiment, there is provided a computer program comprising computer program code, the computer program code being configured to perform at least the following:
identify a displayed graphical user interface element based on a first selection user input associated with the location of the graphical user interface element on a touch sensitive display; and
confirm selection of the identified graphical user interface element based on a second confirmation user input associated with the location of the identified graphical user interface element on the touch sensitive display;
wherein the first selection user input and the second confirmation user input are respective different input types of an eye gaze user input and a touch user input.

According to a further example embodiment, there is provided a method, the method comprising:
identifying a displayed graphical user interface element based on a first selection user input associated with the location of the graphical user interface element on a touch sensitive display; and
confirming selection of the identified graphical user interface element based on a second confirmation user input associated with the location of the identified graphical user interface element on the touch sensitive display;
wherein the first selection user input and the second confirmation user input are respective different input types of an eye gaze user input and a touch user input.

According to a further example embodiment there is provided an apparatus comprising:
means for identifying a displayed graphical user interface element based on a first selection user input associated with the location of the graphical user interface element on a touch sensitive display; and
means for confirming selection of the identified graphical user interface element based on a second confirmation user input associated with the location of the identified graphical user interface element on the touch sensitive display;
wherein the first selection user input and the second confirmation user input are respective different input types of an eye gaze user input and a touch user input.

The present disclosure includes one or more corresponding aspects, embodiments or features in isolation or in various combinations whether or not specifically stated (including claimed) in that combination or in isolation. Corresponding means and corresponding function units (e.g., first selection user input associator, second confirmation user input associator, graphical user interface element identifier, selection confirmer) for performing one or more of the discussed functions are also within the present disclosure.

A computer program may be stored on a storage media (e.g. on a CD, a DVD, a memory stick or other non-transitory medium). A computer program may be configured to run on a device or apparatus as an application. An application may be run by a device or apparatus via an operating system. A computer program may form part of a computer program product. Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus embodiment comprising a number of electronic components, including memory and a processor, according to one embodiment of the present disclosure;

FIG. 2 illustrates an example apparatus embodiment comprising a number of electronic components, including memory, a processor and a communication unit, according to another embodiment of the present disclosure;

FIG. 3 illustrates an example apparatus embodiment comprising a number of electronic components, including memory and a processor, according to another embodiment of the present disclosure;

FIGS. 4a-4d illustrate identifying and confirming selection of an icon according to embodiments of the present disclosure;

FIGS. 5a-5d illustrate identifying and confirming selection of a contact in a contact list according to embodiments of the present disclosure;

FIGS. 6a-6d illustrate identifying and confirming selection of an icon according to embodiments of the present disclosure;

FIGS. 7a-7b illustrate detection of an eye gaze location on a display according to embodiments of the present disclosure;

FIG. 8 illustrates detection of a hover/touch user input according to embodiments of the present disclosure;

FIGS. 9a-9b each illustrate an apparatus in communication with a remote computing element;

FIGS. 10 illustrates a flowchart according to an example method of the present disclosure; and

FIG. 11 illustrates schematically a computer readable medium providing a program.

### DESCRIPTION OF EXAMPLE ASPECTS/EMBODIMENTS

Electronic devices allow users to select displayed objects in different ways. For example, a user may move a pointer on screen over an icon and click a mouse button to select the icon. A user may be able to touch a touch sensitive display screen in a particular region over a displayed virtual button and press the button.

Certain electronic devices are able to detect where a user is looking on the display screen. This eye gaze location may be used to make inputs to the electronic device. Certain electronic devices can detect the position of a stylus hovering above or touching a touch/hover sensor either over a display or separate to a display. This touch/hover input may also be used to make inputs to the electronic device.

It may be desirable for a user to combine two types of user input. For example, it may be useful to confirm the input made using one method by using an input made by another method. This may be desirable to improve input accuracy (and reduce the likelihood of accidentally selecting a neighbouring icon, for example). This may be particularly beneficial when using input methods which may allow for more ambiguous interpretation, for example in relation to the position of the input. For example, if a user clicks on an icon with a mouse pointer, usually the location of the tip of the pointer is taken to be the location where the selection is made by the click and thus the location of the selection is well pinpointed. If a user touches a touch sensitive display with a finger, then if the user's fingertip covers more than one selectable object, it may be unclear which object the user intended to interact with. The wrong object, or no object, may be selected which is undesirable for the user who must then try and make the same input again and hope the intended object is targeted.

It may be desirable to provide feedback to a user, so that he/she is aware of what input the electronic device is detecting and where it is detected. For example, a user making input via detection of an eye gaze location may benefit from receiving feedback indicating where on a display the user's eye gaze is detected.

Embodiments discussed herein may be considered to identify a displayed graphical user interface element based on a first selection user input associated with the location of the graphical user interface element on a touch sensitive display, and to confirm selection of the identified graphical user interface element based on a second confirmation user input associated with the location of the identified graphical user interface element on the touch sensitive display. The first selection user input and the second confirmation user input are respective different input types of an eye gaze user input and a touch user input. The touch user input may be a physical touch or a hover (non-contact) user input.

The inputs are both associated with the location of the displayed graphical user interface element. Thus a user may be able to intuitively select and confirm selection by directly interacting with the object of interest in a natural way (by looking at it and by touching it or pointing to it). For example, a user may look at an icon to select it, and may then hover over it to confirm the eye gaze selection. As another example, a user may hover over a contact entry, and may look at the contact entry to confirm the hover input.

Advantageously, the selection confirmation is made using a second different input method, thus reducing the likelihood of a user accidentally selecting items which are not of interest if only one user input method was used to make the selection and confirmation. The second confirmation user input may be considered to improve the resolution of the input sensor(s), because two independent input methods are used to select, and confirm selection of, one graphical user interface element. A user may be able to select a displayed object of interest with intuitive gestural inputs and by looking at the object, without necessarily requiring the accurate placement of a touch user input with a stylus small enough to touch one object without touching any neighbouring objects, for example.

Advantageously, the user may receive feedback of the selection and of the confirmation, thereby allowing the user to understand how their inputs are being detected. The user may be trained how to make inputs for that device by receiving feedback and reacting to the feedback. The user may be allowed to change the device settings so that the device detects the user's inputs in the way the user wants. The identification based on a first selection user input may or may not provide some visual/audio/haptic feedback to the user. In the case that no feedback is provided, the identification can be considered an internal identification of one or more graphical user interface elements associated with the first selection user input location.

Other embodiments depicted in the figures have been provided with reference numerals that correspond to similar features of earlier described embodiments. For example, feature number 100 can also correspond to numbers 200, 300 etc. These numbered features may appear in the figures but may not have been directly referred to within the description of these particular embodiments. These have still been provided in the figures to aid understanding of the further embodiments, particularly in relation to the features of similar earlier described embodiments.

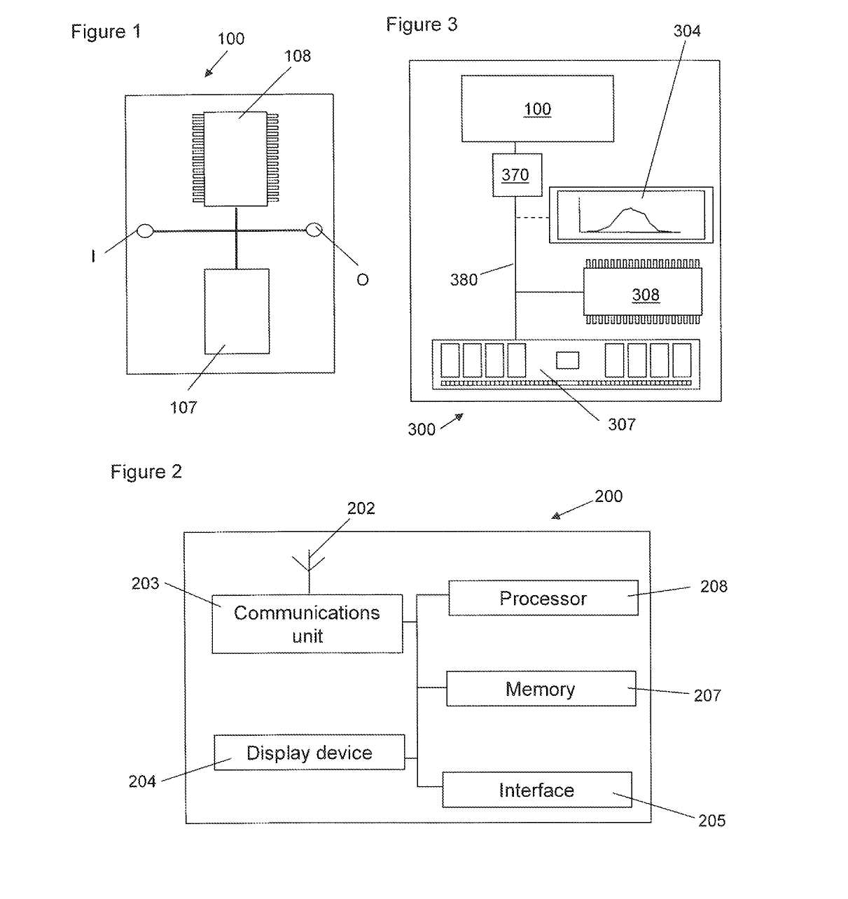

FIG. 1 shows an apparatus 100 comprising memory 107, a processor 108, input I and output O. In this embodiment only one processor and one memory are shown but it will be appreciated that other embodiments may utilise more than one processor and/or more than one memory (e.g. same or different processor/memory types).

In this embodiment the apparatus 100 is an Application Specific Integrated Circuit (ASIC) for a portable electronic device with a touch sensitive display. In other embodiments the apparatus 100 can be a module for such a device, or may be the device itself, wherein the processor 108 is a general purpose CPU of the device and the memory 107 is general purpose memory comprised by the device. The display, in other embodiments, may not be touch sensitive.

The input I allows for receipt of signaling to the apparatus 100 from further components, such as components of a portable electronic device (like a touch-sensitive or hover-sensitive display, or camera) or the like. The output O allows for onward provision of signaling from within the apparatus 100 to further components such as a display screen, speaker, or vibration module. In this embodiment the input I and output O are part of a connection bus that allows for connection of the apparatus 100 to further components.

The processor 108 is a general purpose processor dedicated to executing/processing information received via the input I in accordance with instructions stored in the form of computer program code on the memory 107. The output signaling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more example embodiments, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 107, 108. In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus 200 of a further example embodiment, such as a mobile phone. In other example embodiments, the apparatus 200 may comprise a module for a mobile phone (or PDA or audio/video player), and may just comprise a suitably configured memory 207 and processor 208.

The example embodiment of FIG. 2 comprises a display device 204 such as, for example, a liquid crystal display (LCD), e-Ink or touch/hover-screen user interface. The apparatus 200 of FIG. 2 is configured such that it may receive, include, and/or otherwise access data. For example, this example embodiment 200 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. This example embodiment comprises a memory 207 that stores data, possibly after being received via antenna 202 or port or after being generated at the user interface 205. The processor 208 may receive data from the user interface 205, from the memory 207, or from the communication unit 203. It will be appreciated that, in certain example embodiments, the display device 204 may incorporate the user interface 205. Regardless of the origin of the data, these data may be outputted to a user of apparatus 200 via the display device 204, and/or any other output devices provided with apparatus. The processor 208 may also store the data for later use in the memory 207. The memory 207 may store computer program code and/or applications which may be used to instruct/enable the processor 208 to perform functions (e.g. read, write, delete, edit or process data). The user interface 205 may provide for the first selection user input and/or the second confirmation user input. This functionality may be integrated with the display device 204 in some examples.

FIG. 3 depicts a further example embodiment of an electronic device 300 comprising the apparatus 100 of FIG. 1. The apparatus 100 can be provided as a module for device 300, or even as a processor/memory for the device 300 or a processor/memory for a module for such a device 300. The device 300 comprises a processor 308 and a storage medium 307, which are connected (e.g. electrically and/or wirelessly) by a data bus 380. This data bus 380 can provide an active coupling between the processor 308 and the storage medium 307 to allow the processor 308 to access the computer program code. It will be appreciated that the components (e.g. memory, processor) of the device/apparatus may be linked via cloud computing architecture. For example, the storage device 307 may be a remote server accessed via the internet by the processor.

The apparatus 100 in FIG. 3 is connected (e.g. electrically and/or wirelessly) to an input/output interface 370 that receives the output from the apparatus 100 and transmits this to the device 300 via data bus 380. Interface 370 can be connected via the data bus 380 to a display 304 (touch-sensitive or otherwise) that provides information from the apparatus 100 to a user. Display 304 can be part of the device 300 or can be separate. The device 300 also comprises a processor 308 configured for general control of the apparatus 100 as well as the device 300 by providing signaling to, and receiving signaling from, other device components to manage their operation.

The storage medium 307 is configured to store computer code configured to perform, control or enable the operation of the apparatus 100. The storage medium 307 may be configured to store settings for the other device components. The processor 308 may access the storage medium 307 to retrieve the component settings in order to manage the operation of the other device components. The storage medium 307 may be a temporary storage medium such as a volatile random access memory. The storage medium 307 may also be a permanent storage medium such as a hard disk drive, a flash memory, a remote server (such as cloud storage) or a non-volatile random access memory. The storage medium 307 could be composed of different combinations of the same or different memory types.

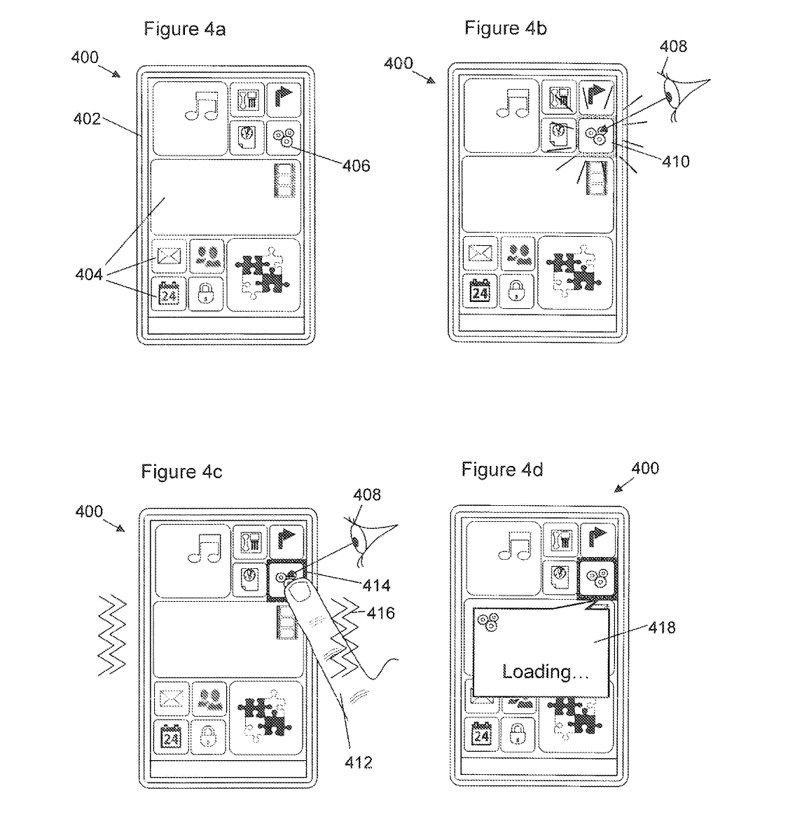

FIGS. 4a-4d illustrate example embodiments of an apparatus/device 400 in use comprising a touch sensitive display 402 displaying a plurality of tiles/icons 404. The user wishes to open a settings menu by selecting the settings tile/icon 406. FIG. 4a shows the apparatus/device 400 before any user inputs have been made.

In FIG. 4b the user looks at the settings tile/icon 406. The user's eye gaze 408 is detected as being directed towards the settings tile/icon 406. This first selection user input 408 is associated with the location of the graphical user interface element 406 on the touch sensitive display 402, since the user is looking at the tile/icon 406 on the display 402. The apparatus/device identifies the displayed graphical user interface element 406 based on the detected eye gaze location. In this example a flashing border 410 appears around the settings tile/icon 406 to indicate that it has been selected. Of course in other examples a different visual, audio and/or haptic highlight (or in some cases, no highlight) may be provided to indicate selection.

In FIG. 4c the user hovers a finger 412 over the settings tile/icon 406. The user's hovering finger 412 is detected as being directed towards the same tile/icon 406. This second confirmation user input 412 is associated with the location of the graphical user interface element 406 on the touch sensitive display 402 since the user's fingertip is located over the displayed tile/icon 406. The apparatus/device 400 confirms selection of the displayed graphical user interface element 406 based on the detected hover location. In this example a non-flashing coloured border 414 appears around the settings tile/icon 406 as visual feedback to indicate that it has been selected and that the selection has been confirmed.

In this example haptic feedback 416 is also provided upon confirmation selection being made by the hover user input 412. The apparatus/device 400 is configured to confirm the selection of the identified graphical user interface element 406 by a haptic highlight indication 416 and by a non-flashing visual highlight indication 414. The visual highlight provided upon confirmation is different to the flashing visual highlight 410 provided during the identification of the displayed graphical user interface element 406 by the selection user input 408.

In FIG. 4d, due to the confirmation selection being made, the application 418 associated with the selected settings tile/icon 406 is actuated and the application loads. Thus the confirmation of selection of the graphical user interface element 406 made using a hover user input 412 in this example provides for actuation of the functionality associated with the identified graphical user interface element 406, thereby opening the settings application 418 associated with the graphical user interface element 406.

Thus the touch sensitive display 402 is configured to detect hover touch input 412, and the apparatus/device 400 is configured such that the identification of the graphical user interface element 406 is made based on the first selection user input of an eye gaze user input 408 and the confirmation of selection is made based on the second confirmation user input of a touch user input which is a hover touch user input 412.

In this example the identification of the settings tile/icon 406 made in response to the eye gaze input 408 is a temporary identification. That is, the identification is cancelled upon removal of the eye gaze user input 408 from the location of the settings tile/icon graphical user interface element 406. It may be considered that the apparatus/device 400 is configured to confirm selection of the displayed graphical user interface element 406 based on the touch/hover user input 412 and the eye gaze user input 408 at least partially overlapping in time. This is shown in FIG. 4c where both the eye gaze 408 and the hover input 412 are being made simultaneously (note that the eye gaze 408 is initially made without an accompanying hover user input as shown in FIG. 4b although in other cases, the respective inputs could be substantially simultaneous). The user may benefit from being less likely to accidentally select icons just by looking at the display screen without intending to select a particular graphical user interface element when both the eye gaze user input 408 and the hover user input 412 must at least partially overlap in time.

For example, if the user looks away from the settings tile/icon without first providing a hover user input 412 associated with the same graphical user interface element 406, or if the user looks away at a different displayed graphical user interface element, then the selection of the settings tile/icon 406 would be cancelled. The flashing border 410 would disappear to indicate this cancellation of selection user input. The flashing border may appear on a different graphical user interface element if the user looks at a different graphical user interface element, or re-appear on the same graphical user interface element 406 if the user looks away then looks back at the same tile/icon 406.

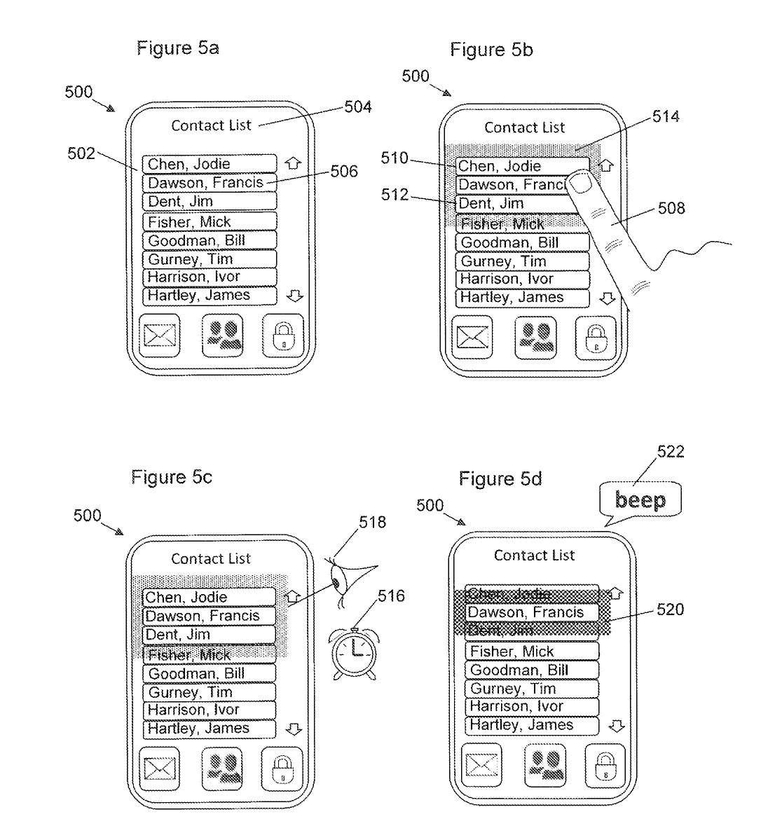

FIGS. 5a-5d illustrate example embodiments of an apparatus/device 500 in use comprising a touch sensitive display 502 displaying a contact list 504. The user wishes to contact a particular contact 506 (Francis Dawson) listed in the contacts list 504 by selecting the corresponding contact entry 506.

In FIG. 5b the user holds/hovers his finger 508 over the region of the touch sensitive display 502 displaying the contact of interest 506. The user's hover input 508 in this example is detected as being directed towards the contact of interest 506 and also to the contacts listed directly above (Jodie Chen 510) and below (Jim Dent 512) the contact of interest. This user's input is not made accurately enough in this example to pick out only one contact entry from the list 504.

In this example the apparatus/device is unable to reliably determine which one contact entry the user wishes to select based only on the user's hover user input. This may be because, for example, the displayed contact entries 506, 510, 512 are very small and the resolution of the touch sensitive display 502 cannot determine a single contact entry 506, but can determine a group of three neighbouring contact entries 506, 510, 512. Other reasons may be that the user's finger 508 is hovering at a large distance (for example, 5 cm) from the touch sensitive display 502, or the user's finger 508 is moving around over the touch sensitive display 502, and so the detected location of the hover input 508 cannot be pinpointed better than being associated with a region covering the three contact entries 506, 510, 512.

This first selection user input 508 is associated with the location of the graphical user interface element 506 on the touch sensitive display 502 (along with neighbouring graphical user interface elements 510, 512 in this example). The apparatus/device 500 identifies the displayed graphical user interface element 506 based on the detected hover user input location 508. In this example a light coloured border 514 appears around the selected contact entries 506, 510, 512 to indicate that they have been selected.

In FIG. 5c the user has removed his hovering finger 508 and, within a predetermined period of time 516, he looks at the contact entry of interest 506. Since the eye gaze user input 518 was made within the predetermined period of time 516, the input is associated with the earlier hover user input 508 and the apparatus/device 500 is configured to determine that the eye gaze user input 518 is a selection confirmation. The user's eye gaze 518 is detected as being directed towards the central contact entry 506 of the three selected contact entries 506, 510, 512. This second confirmation user input 518 is associated with the location of the graphical user interface element 506 on the touch sensitive display 502.

In FIG. 5d, the apparatus/device 500 confirms selection of the displayed graphical user interface element 506 based on the detected eye gaze 518 location over a contact selected by the prior hovering selection user input 508. In this example a brighter coloured border 520 appears around the selected contact entry 506 as visual feedback to indicate that it has been selected. In this example audio feedback 522 is also provided upon confirmation selection 518 being made. Of course the audio feedback may not be a “beep” but may, for example, recite the name of the contact who has been selected, or may recite an action to be performed using that selected contact (such as “calling Francis Dawson”, for example).

The apparatus/device 500 is configured to confirm the selection of the identified graphical user interface element 506 by an audio highlight indication 522 and by a bright visual highlight indication 520 which is different to the light coloured visual highlight 514 provided during the identification of the displayed graphical user interface elements 506, 510, 512 made by the selection user input 508. In other examples, the second confirmation user input may be highlighted by the highlight provided upon selection plus an additional highlight, such as the light border 514 and an audio or haptic feedback being provided on confirmation.

The apparatus/device may allow the user to select an action to perform for the selected contact, such as selecting a displayed option to contact the selected contact by, for example, telephone call, SMS message, MMS message, e-mail, or chat message (e.g., by presenting other selectable options). In other examples, the user may be automatically presented with a default communications application for communicating with the selected contact upon the confirmation selection 518 being detected. For example, after the visual and audio indications provided as in FIG. 5d, an e-mail application may be automatically opened with the recipient information already completed for contact Francis Dawson, or a telephone call may automatically be initiated.

Thus the confirmation of selection of the graphical user interface element 506 made using an eye gaze user input 518 may provide for actuation of the functionality associated with the identified graphical user interface element 506, thereby initiating a communication with a contact associated with the graphical user interface element 506.

In this example, the first selection user input is a hover user input 508 and the second confirmation user input is an eye gaze input 518. In such examples the touch sensitive display 502 is configured to detect hover touch input 508, and the apparatus/device 500 is configured such that the identification of the graphical user interface element 506 is made based on the touch user input 508, which is a hover touch user input, using the touch sensitive display 502 and the confirmation of selection is made based on the eye gaze user input 518.

In this example, the identification of the contact entry 506 made in response to the hover user input 508 is a sustained identification. That is, the identification remains after removal of the hover user input 508 associated with the location of the graphical user interface element 506 for a predetermined time period 516. It may be considered that the apparatus/device 500 is configured to confirm selection of the displayed graphical user interface element 506 based on the touch user input 508 and the eye gaze user input 518 being separated in time by an input time period lower than a predetermined input time threshold 516. The predetermined time period threshold 516 may be, for example three seconds. It may be defined by a user, or by the manufacturer, and/or may be adjusted according to user habits.

Thus if the user hovers over the contact entry 506 to make a selection input, and then moves his finger away, the selection 514 may remain for a predetermined time period after the hover user input 508 has ended. This may provide the user with the benefit of being able to select contact entries (or icons, buttons etc.) and provide a second confirmation user input after selection while also being able to move his hand/finger away for the predetermined period of time.

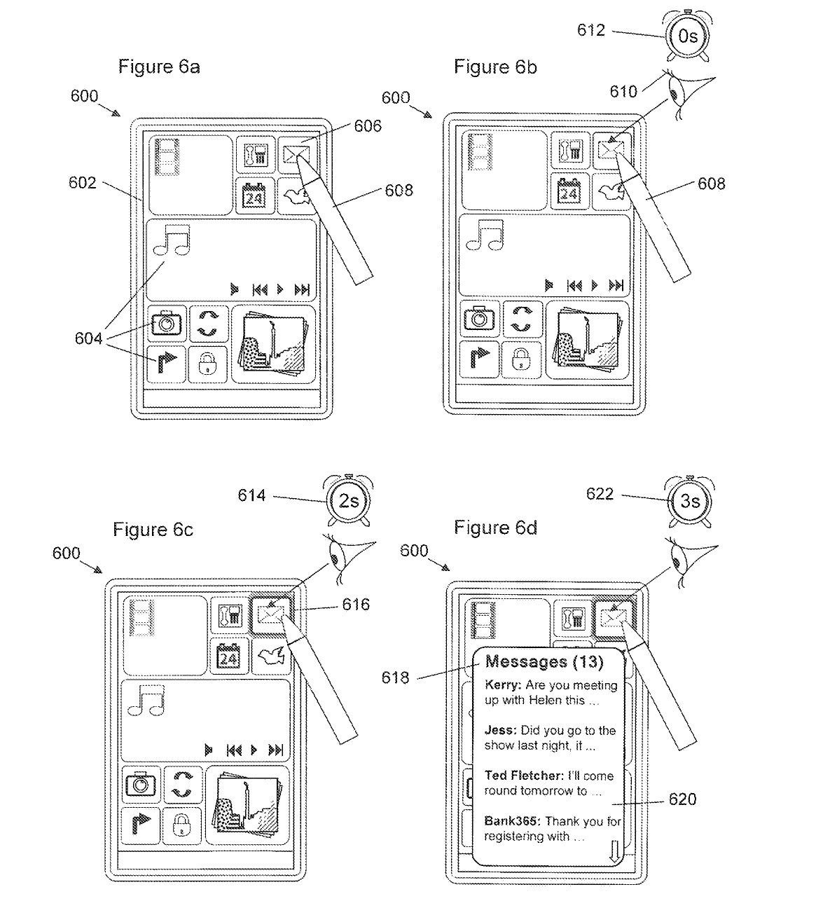

FIGS. 6a-6d illustrate example embodiments of an apparatus/device 600 in use comprising a touch sensitive display 602 displaying a series of tiles/icons 604. The user wishes to open an e-mail application by selecting an e-mail application tile/icon 606 with a stylus/pen 608.

In FIG. 6a the user holds a pen 608 over the region of the touch sensitive display 602 displaying the e-mail application icon 606. This first selection user input 608 is associated with the location of the graphical user interface element 606 on the touch sensitive display 602. The apparatus/device 600 identifies the displayed graphical user interface element 606 based on the detected hover user input location 608. In this example no indication is yet provided for the user that the selection has been made (but the apparatus/device 600 has detected the selection). In other examples an indication may be provided to the user, such as a beep, vibration, or visual cue, for example.

In FIG. 6b the user keeps the pen 608 over the e-mail application icon 606 and also directs his gaze 610 to the same icon 606. This eye gaze input 610 is detected by the apparatus/device 600 and the detection starts a clock 612 which measures the time for which both the hover user input 608 and the eye gaze user input 610 are made to the same graphical user interface element 606.

FIG. 6c shows that after a first time period 614 (in this example, two seconds) the apparatus/device 600 provides a first indication of confirmation which is a bold coloured border 616 around the selected email application icon 606. This first confirmation of selection 616 is indicated to the user because both the eye gaze user input 610 to the e-mail application icon 606 and the hover user input 608 have been detected (i.e., the inputs are overlapping in time), and the eye gaze input 610 has been determined to last for the first time period 614.

FIG. 6d shows that, after continuation 622 of the eye gaze input 610, (in this example, three seconds have passed since the user's eye gaze input 610 was first detected, but it could be more or less time in other examples) the apparatus/device 600 provides second subsequent different indication of confirmation. In this example the second subsequent different indication of confirmation is actually the opening of the e-mail messaging application 618 associated with the selected e-mail application icon 606.

Thus the user can select a graphical user interface element 606 using a hover user input 608, can confirm the selection using an eye gaze input 610, and by continuing the eye gaze input 610, a different indication 620 of the confirmation of selection is provided by the application being opened. Respective hover/gaze user inputs may be used if they are overlapping in time or a predetermined period, for example if they overlap in time by one second, or two seconds, or half a second, for example. The overlap time may be set by a user in some examples.

In examples where the apparatus/device provides a visual indication of a selection input and/or a confirmation of selection input, the visual indication may be provided by modifying the display of the graphical user interface element by applying a pulsing visual effect (such as a flashing or variable colour scheme), applying a border effect, applying a colour effect (such as highlighting the graphical user interface element in a particular colour with a colour overlay, background, or border), applying a shading effect (for example, by providing a shadow effect), changing the size of the graphical user interface element (for example, magnifying the graphical user interface element or the region of the display showing the graphical user interface element) and/or changing the style of the graphical user interface element (for example, displaying text in bold, italics, and/or underline, or changing the fonts style or size).

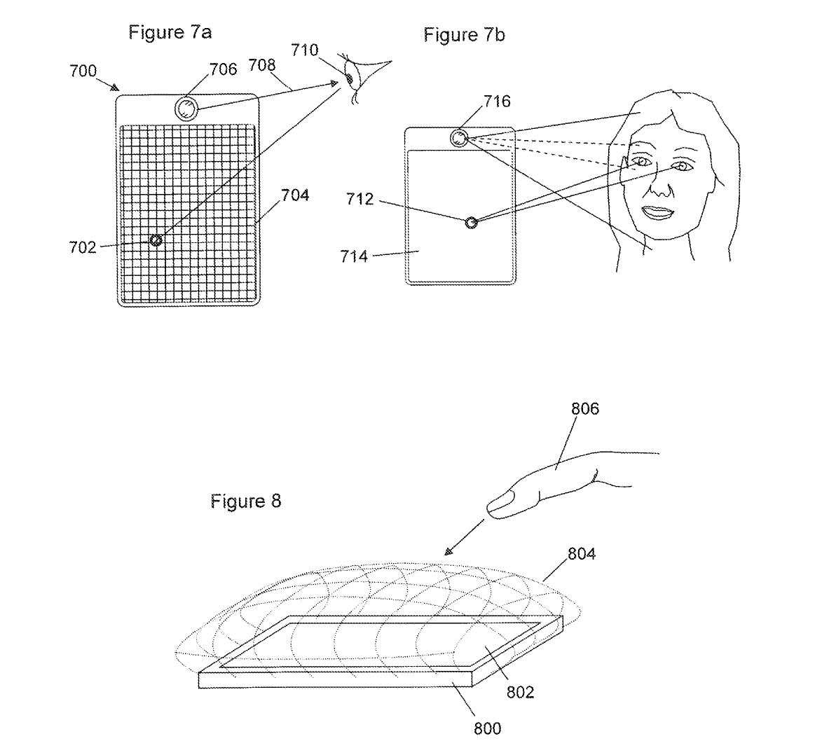

FIGS. 7a-7b illustrate detection of an eye gaze location on a display of an apparatus/device 700 according to embodiments of the present disclosure.

FIG. 7a shows that the location of a user's eye gaze 702 on a display 704 may be detected using a front facing camera 706 (such as a visual camera or an infra-red camera). An infrared beam 708 is projected towards the user's face, and the beam 708 is reflected by the user's pupil 710. Algorithms are able to determine where the user is looking 702 by detecting the properties of the reflected infra red beam.

FIG. 7b shows that the location of a user's eye gaze 712 on a display 714 may be detected using a front facing camera 716 and facial recognition software. The front-facing camera 716 can record images of the user's face and eye positions. The images may be processed to determine the user's eye and facial movements, and convert these movements and positions into a determined position of a user's gaze.

In the above examples, the user's eye gaze may be determined to be an input if the gaze is detected to be made in substantially the same location (within a particular threshold) for a minimum amount of time. For example, if a user's gaze is detected as being directed to a particular pixel, then provided the gaze remains at the pixel or within a distance of 20 pixels (the threshold for location variation) for a minimum time of 0.5 seconds, the gaze may be considered as an input. If the user's gaze moves locations before 0.5 seconds has passed, this may be interpreted as the user not making an input with his/her gaze, but that the user is merely reviewing what is displayed on the screen. In this way the apparatus is not continuously determining the user's gaze as a series of inputs when the user is merely reading/viewing the screen contents.

In the above examples, the user's selection and confirmation are used to select a contact from a contact list and to open an application. Other examples of graphical user interface elements which may be selected using examples described here include: pressing a virtual button, checking a check box, moving a virtual Boolean switch on/off, displaying a pop-up or drop-down menu, selecting a menu item (not necessarily a contact entry in an address book), unlocking a device by hovering/touch and looking a predetermined location or series of locations on the lock screen, and scrolling left/right and up/down using a scroll arrow or page up/down controls.

FIG. 8 illustrates detection of a hover/touch user input according to embodiments of the present disclosure. The display screen 802 of an apparatus/device 800 may be (or be overlaid by) a 3-D hover-sensitive layer. Such a layer may be able to generate a virtual mesh 804 in the area surrounding the display screen 802 up to a distance from the screen 802 of, for example 5 cm. The virtual mesh 804 may be generated as a capacitive field in some examples. The 3-D hover-sensitive layer may be able to detect hovering objects 806, such as a finger or pen, within the virtual mesh 804 and objects 806 touching the display screen 802. The virtual mesh 804 may extend past the edges of the display screen 802 in the plane of the display screen 802. The virtual mesh 804 may be able to determine the shape, location, movements and speed of movement of the object 806 based on objects detected within the virtual mesh 804.

Although hover user inputs are used in the above described examples, in other examples a physical touch user input may be detected as either the selection input or the confirmation selection user input. Thus in some examples the touch sensitive display may be configured to detect a hover touch user input made by a stylus pointing to the graphical user interface element displayed on the touch sensitive display at a separation distance of 0 mm or greater from the surface of the touch sensitive display but within the distance range detectable by the touch sensitive display.

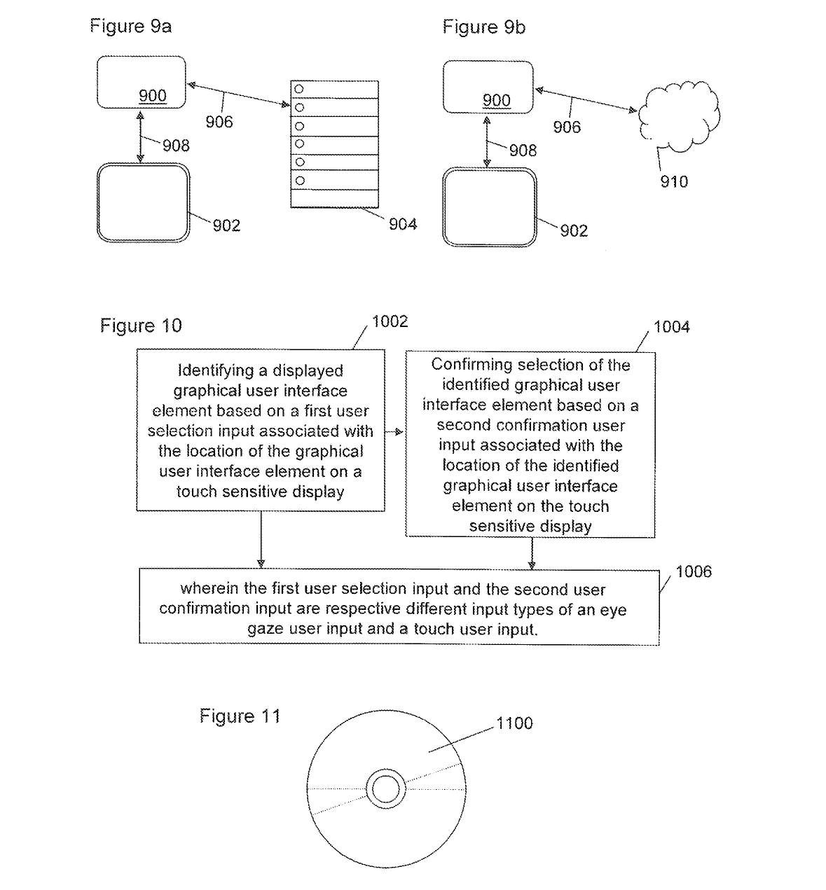

FIG. 9a shows an example of an apparatus 900 in communication 906 with a remote server. FIG. 9b shows an example of an apparatus 900 in communication 906 with a “cloud” for cloud computing. In FIGS. 9a and 9b, apparatus 900 (which may be apparatus 100, 200 or 300) is also in communication 908 with a further apparatus 902. The apparatus 902 may be a touch sensitive display or a camera for example. In other examples, the apparatus 900 and further apparatus 902 may both be comprised within a device such as a portable communications device or PDA. Communication 906, 908 may be via a communications unit, for example.

FIG. 9a shows the remote computing element to be a remote server 904, with which the apparatus 900 may be in wired or wireless communication 906 (e.g. via the internet, Bluetooth, NFC, a USB connection, or any other suitable connection as known to one skilled in the art). In FIG. 9b, the apparatus 900 is in communication 906 with a remote cloud 910 (which may, for example, be the Internet, or a system of remote computers configured for cloud computing).

For example, the further apparatus 902 may be a 3-D hover sensitive display and may detect distortions in its surrounding field caused by a proximal object. The measurements may be transmitted via the apparatus 900 to a remote server 904 for processing and the processed results, indicating an on-screen position of a hovering object, may be transmitted to the apparatus 900. As another example, the further apparatus 902 may be a camera and may capture images of a user's face and eye positions in front of the camera. The images may be transmitted via the apparatus 900 to a cloud 910 for (e.g., temporary) recordal and processing. The processed results, indicating an on-screen eye gaze position, may be transmitted back to the apparatus 900. In some examples, information accessed in relation to applications opened using the hover/eye gaze combination user input may be stored remotely, such as messages, images and games. In other examples the second apparatus 902 may also be in direct communication with the remote server 904 or cloud 910.

FIG. 10a illustrates a method 1000 according to an example embodiment of the present disclosure. The method 1000 comprises identifying a displayed graphical user interface element based on a first selection user input associated with the location of the graphical user interface element on a touch sensitive display 1002; and confirming selection of the identified graphical user interface element based on a second confirmation user input associated with the location of the identified graphical user interface element on the touch sensitive display 1004; wherein the first selection user input and the second confirmation user input are respective different input types of an eye gaze user input and a touch user input 1006.

FIG. 11 illustrates schematically a computer/processor readable medium 1100 providing a program according to an embodiment. In this example, the computer/processor readable medium is a disc such as a Digital Versatile Disc (DVD) or a compact disc (CD). In other embodiments, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signaling” may refer to one or more signals transmitted as a series of transmitted and/or received electrical/optical signals. The series of signals may comprise one, two, three, four or even more individual signal components or distinct signals to make up said signaling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to example embodiments thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
identify a displayed graphical user interface element based on a first selection user input associated with the location of the graphical user interface element on a touch sensitive display; and
confirm selection of the identified graphical user interface element based on a second confirmation user input associated with the location of the identified graphical user interface element on the touch sensitive display;
wherein the first selection user input and the second confirmation user input are respective different input types of an eye gaze user input and a touch user input.

2. The apparatus of claim 1, wherein the touch sensitive display is configured to detect one or more of physical touch input and hover touch input.

3. The apparatus of claim 1, wherein the apparatus is configured to disambiguate a particular graphical user interface element from one or more adjacent graphical user interface elements associated with the location of the first selection user input by using the second confirmation user input.

4. The apparatus of claim 1, wherein the touch sensitive display is configured to detect hover touch input, and the apparatus is configured such that the identification of the graphical user interface element is made based on the touch user input, which is a hover touch user input, using the touch sensitive display and the confirmation of selection is made based on the eye gaze user input.

5. The apparatus of claim 1, wherein the touch sensitive display is configured to detect hover touch input, and the apparatus is configured such that the identification of the graphical user interface element is made based on the eye gaze user input and the confirmation of selection is made based on the touch user input which is a hover touch user input.

6. The apparatus of claim 1, wherein the confirmation of selection of the graphical user interface element provides for actuation of the functionality associated with the identified graphical user interface element.

7. The apparatus of claim 6, wherein the actuation of the functionality associated with the identified graphical user interface element comprises one or more of:
opening an application associated with the graphical user interface element;
selecting an option associated with the graphical user interface element; and
initiating a communication with a contact associated with the graphical user interface element.

8. The apparatus of claim 1, wherein the identification of the graphical user interface element is one or more of:
a temporary identification, wherein the identification is cancelled upon removal of the user input associated with the location of the graphical user interface element; and
a sustained identification, wherein the identification remains after removal of the user input associated with the location of the graphical user interface element for a predetermined time period.

9. The apparatus of claim 1, wherein the apparatus is configured to confirm selection of the displayed graphical user interface element based on one or more of:
the touch user input and the eye gaze user input at least partially overlapping in time; and
the touch user input and the eye gaze user input being separated in time by an input time period lower than a predetermined input time threshold.

10. The apparatus of claim 1, wherein the apparatus is configured to confirm selection of the identified graphical user interface element after:
providing a first indication of confirmation following determination of the eye gaze user input associated with the location of the graphical user interface element for a first time period; and
providing a second subsequent different indication of confirmation during the continued determined eye gaze user input.

11. The apparatus of claim 1, wherein the apparatus is configured to identify the displayed graphical user interface element by one or more of: a visual highlight indication, a haptic highlight indication, and an audio highlight indication.

12. The apparatus of claim 1, wherein the apparatus is configured to confirm the selection of the identified graphical user interface element by one or more of: a visual highlight indication, a haptic highlight indication, and an audio highlight indication which is different to any highlight provided during the identification of the displayed graphical user interface element by the selection user input.

13. The apparatus of claim 12, wherein the apparatus is configured to provide the visual indication by modifying the display of the graphical user interface element by one or more of:
applying a pulsing visual effect, applying a border effect, applying a colour effect, applying a shading effect; changing the size of the graphical user interface element, changing the style of the graphical user interface element.

14. The apparatus of claim 1, wherein the touch sensitive display is configured to detect a hover touch user input made by a stylus pointing to the graphical user interface element displayed on the touch sensitive display at a separation distance of 0 mm or greater from the surface of the touch sensitive display but within the distance range detectable by the touch sensitive display.

15. The apparatus of claim 1, wherein the apparatus is configured to perform detection of the touch user input using a capacitive touch sensor.

16. The apparatus of claim 1, wherein the apparatus is configured to perform detection of the eye gaze user input using one or more of: eye-tracking technology and facial recognition technology.

17. The apparatus of claim 1, wherein the apparatus is configured to perform one or more of:
detection of the touch user input associated with the displayed graphical user interface element; and
detection of the eye gaze user input associated with the displayed graphical user interface element.

18. The apparatus of claim 1, wherein the apparatus is one or more of: a portable electronic device, a mobile phone, a smartphone, a tablet computer, a surface computer, a laptop computer, a personal digital assistant, a graphics tablet, a digital camera, a watch, a pen-based computer, a non-portable electronic device, a desktop computer; a monitor/display, a household appliance, a server, or a module for one or more of the same.

19. A computer readable medium comprising computer program code stored thereon, the computer readable medium and computer program code being configured to, when run on at least one processor perform at least the following:
identify a displayed graphical user interface element based on a first selection user input associated with the location of the graphical user interface element on a touch o sensitive display; and
confirm selection of the identified graphical user interface element based on a second confirmation user input associated with the location of the identified graphical user interface element on the touch sensitive display;
wherein the first selection user input and the second confirmation user input are respective different input types of an eye gaze user input and a touch user input.

20. A method comprising:
identifying a displayed graphical user interface element based on a first selection user input associated with the location of the graphical user interface element on a touch sensitive display; and
confirming selection of the identified graphical user interface element based on a second confirmation user input associated with the location of the identified graphical user interface element on the touch sensitive display;
wherein the first selection user input and the second confirmation user input are respective different input types of an eye gaze user input and a touch user input.
